(19) United States
(12) Patent Application Publication
(10) Pub. No.: US 2004/0176012 A1
(43) Pub. Date: Sep. 9, 2004

(54) Model castle top, model castle assembly, method for applying crenellated parapet and method for assembling a model castle

(76) Inventor: James B. Hirtz, Chicago, IL (US)

Correspondence Address: PATENTS+TMS, A Professional Corporation, 1914 North Milwaukee Avenue, Chicago, IL, 60647, US

(21) Appl. No.: 10/384,214

(22) Filed: Mar. 7, 2003

(51) Int. Cl. G09B 25/00

(52) U.S. Cl. 446/476; 434/79

(57) ABSTRACT

A model castle formed from a plurality of assembly pieces includes towers, walls, roofs and a castle top. The model castle may be formed on a base or may stand alone. The castle top of the model castle may be a crenallated parapet that is easy to manipulate. The crenallated parapet has crenels and merlons giving a realistic appearance. Flags, windows and paper simulating brick or stone may be added to the castle to add to its realistic appearance.

### BACKGROUND OF THE INVENTION

The present invention generally relates to a model castle top, a model castle assembly, a method for applying a crenellated parapet to a castle assembly and a method for assembling a model castle. More specifically, the present invention relates to a model castle top having a crenellated parapet with alternating indentations (crenels) and raised portions (merlons), a model castle assembly, a method for applying a crenellated parapet to a model castle and a method for assembling a castle top model kit with the crenellated parapet.

It is, of course, generally known to build model castles from model castle parts. Model castle kits providing materials necessary for building a castle are also known. Such model castle kits generally include paper, cardboard, foam, balsa wood, paint, glue and/or other castle model pieces. Other known model castle kits do not provide materials necessary for building a castle and leave the modeler to provide his/her own materials. Known model castle kits generally have detailed directions on how to assemble a realistic looking model castle using specific materials. Further, known model castle kits may provide directions for assembling a model castle without providing materials necessary for building a castle.

A problem associated with known model castle kits includes a lack of a realistically simulated roof top of a castle. For example, a crenellated parapet of a castle roof top may be the signature mark of a castle but is difficult to model. The crenellated parapet is defined by merlons and crenels. Merlons are alternating protruding portions of the crenellated parapet. Crenels are alternating indentations of a crenellated parapet. The crenels and the merlons of the crenellated parapet are difficult to simulate. In particular, it is difficult for modelers to evenly space individual construction parts and to accurately remove construction material for model sized castle tops. Further, the crenels and the merlons of the crenellated parapet are difficult to simulate by modelers with limited dexterity.

Individually sold model castle parts are also known. For example, pre-assembled model castle parts, such as a tower or a wall, are available to supplement, extend, or enhance an existing castle model. However, a model castle part that realistically simulates a crenellated parapet and that is easy to use is not available.

A need, therefore, exists for simplified model castle parts. In particular, a need exists for a simplified crenellated parapet part that has a realistic appearance. Furthermore, a need exists for a model crenellated parapet that is easier to handle, particularly by children or people with limited dexterity.

### SUMMARY OF THE INVENTION

The present invention generally relates to a model castle top, a model castle assembly, a method for applying a crenellated parapet to a model castle assembly and a method for assembling a model castle. More specifically, the present invention relates to a model castle top having a crenellated parapet with crenels and merlons.

To this end, in an embodiment of the present invention, a model castle top for a model castle is provided. The top has a parapet having a plurality of protrusions and a plurality of indentations. The parapet has a front face, a back face, a top edge and a bottom edge. The plurality of protrusions are attached to the top edge of the parapet and the plurality of protrusions are spaced equally apart. The plurality of indentations are in the top edge of the parapet and each of the indentations is between the plurality of protrusions.

In an embodiment, the top has an adhesive layer on the back face of the parapet.

In an embodiment, the top has a second plurality of protrusions attached to the bottom edge of the parapet.

In an embodiment, the parapet is flexible.

In an embodiment, the parapet is made from foam.

In an embodiment, the parapet is made from plastic.

In an embodiment, the top has a second parapet having a front face, a back face, a top edge and a bottom edge wherein the second parapet is attached to the back face of the parapet.

In another embodiment of the present invention, a model castle assembly is provided having a plurality of parapets and a plurality of walls. The plurality of parapets each have a front face, a back face, a top edge and a bottom edge. One of the plurality of parapets has a plurality of protrusions attached to the top edge and the plurality of protrusions are spaced equally apart. One of the plurality of parapets are attached to at least one of the plurality of walls.

In an embodiment, the model castle assembly has a plurality of towers associated with the plurality of walls.

In an embodiment, the model castle assembly has a base having a recess for supporting the plurality of walls.

In an embodiment, the model castle assembly has a base having a recess for supporting the plurality of walls.

In an embodiment, the plurality of parapets are flexible.

In an embodiment, the model castle assembly has a roof attached to the plurality of walls.

In an embodiment, the model castle assembly has a window in one of the plurality of walls.

In another embodiment of the present invention, a method for applying a top to a model castle is provided. The method comprises the steps of: providing a parapet having a front face, a back face, a top edge and a bottom edge wherein the parapet has a plurality of protrusions attached to the top edge of the parapet and further wherein the plurality of protrusions are spaced equally apart; aligning the parapet to the model castle; and attaching the parapet to the model castle.

In an embodiment, the method for applying a top to a model castle further comprises the step of providing an adhesive on the back side of the parapet.

In an embodiment, the method for applying a top to a model castle further comprises the step of sizing the parapet to a desired length.

In an embodiment, the method for applying a top to a model castle further comprises the step of attaching two lateral ends of the parapet for positioning on a tower.

In another embodiment of the present invention, a method for assembling a model castle is provided. The method comprises the steps of: providing a plurality of walls; providing a plurality of towers associated with the plurality of walls; providing a parapet having a front face, a back face, a top edge and a bottom edge wherein the parapet has a plurality of protrusions attached to the top edge of the parapet wherein the plurality of protrusions are spaced equally apart; and attaching the parapet to one of the plurality of walls.

In an embodiment, the method for assembling a model castle further comprises the step of applying adhesive on the back side of the parapet.

In an embodiment, the method for assembling a model castle further comprises the step of attaching paper simulating construction materials for covering the plurality of walls and the plurality of towers.

In an embodiment, the method for assembling a model castle further comprises the step of using a base to support the plurality of walls and the plurality of towers.

In an embodiment, the method for assembling a model castle further comprises the step of attaching a window on one of the plurality of walls.

It is, therefore, an advantage of the present invention to provide a model castle top, a model castle assembly, a method for applying a crenellated parapet and a method for assembling a model castle top that is easy to use.

Another advantage of the present invention is to provide a model castle top, a model castle assembly, a method for applying a crenellated parapet and a method for assembling a model castle top kit that is inexpensive.

Another advantage of the present invention is to provide a model castle top, a model castle assembly, a method for applying a crenellated parapet and a method for assembling a model castle top kit that may be trimmed to accommodate the castle assembly.

Yet another advantage of the present invention is to provide a model castle top, a model castle assembly, a method for applying a crenellated parapet and a method for assembling a model castle top kit that is inexpensive to manufacture.

Another advantage of the present invention is to provide a model castle top, a model castle assembly, a method for applying a crenellated parapet and a method for assembling a model castle top kit that is easy to handle, particularly by children or people with limited dexterity.

Yet another advantage of the present invention is to provide a model castle top, a model castle assembly, a method for applying a crenellated parapet and a method for assembling a model castle top kit that is realistic in appearance.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of a model castle in an embodiment of the present invention.

FIG. 2A illustrates a front view of a crenellated parapet for a model castle in an embodiment of the present invention.

FIG. 2B illustrates a front view of a crenellated parapet for a model castle in another embodiment of the present invention.

FIG. 3 illustrates a perspective view of a crenellated parapet for a model castle in another embodiment of the present invention.

FIG. 4 is a flowchart illustrating the steps for applying a crenellated parapet to a model castle in an embodiment of the present invention.

FIG. 5 is a flowchart illustrating the steps for building a model castle in an embodiment of the present invention.

### DETAILED DESCRIPTION OF THE PRESENTLY PREFERRED EMBODIMENTS

The present invention generally relates to a model castle top, a model castle assembly, a method for applying a crenellated parapet to a castle assembly and a method for assembling a model castle top kit. More specifically, the present invention relates to a model castle top having a crenellated parapet with crenels and merlons. To this end, in an embodiment of the present invention, a model castle top has a crenellated parapet formed with indentations and raised portions.

“Parapet” may refer to a wall used to protect any spot having a sudden drop, for example, a parapet may be located at the top of a tower or a top of a wall. “Crenellated” may refer to alternating indentations and raised portions on the parapet. More specifically, “crenellated parapet” may refer to a low wall with alternating indentations and raised portions, known as crenels and merlons, respectively. A crenel may be the low segment of alternating high and low segments on the crenellated parapet. A merlon may be the high segment.

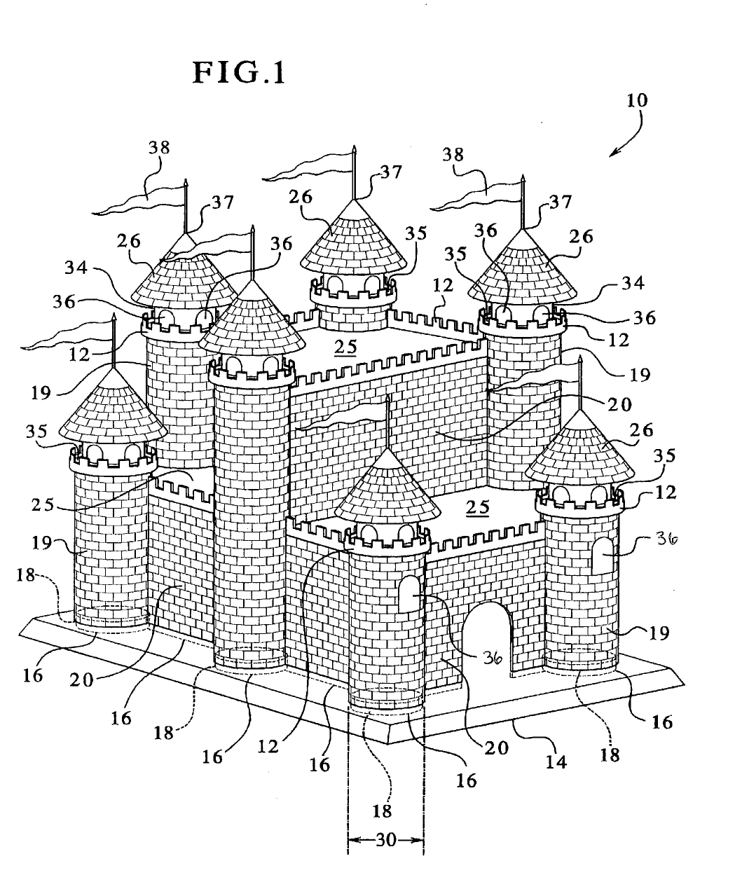

Referring now to the drawings, wherein like numerals refer to like parts, FIG. 1 illustrate a model castle 10 having a model castle top defined by a crenellated parapet 12. The model castle 10, as shown, may have a base 14 having recesses 16. The recesses 16 may receive anchor portions 18 such that the anchor portions 18 protrude from the base 14. The anchor portions 18 may support towers 19 and/or the walls 20. Each of the towers 19 may have an inside diameter 30 larger than an outside diameter 31 of the anchor portions 18. The inside diameter 30 of the towers 19 may engage the outside diameter 31 of the anchor portions 18 protruding from the base 14. The anchor portions 18 may support the towers 19 and/or walls 20 in predetermined locations. Alternatively, the towers 19 and/or walls 20 may be supported by the recesses 16 in the base 14. Still further, the towers 19 and/or the walls 20 may be self-supporting and may not require the use of the base 14. The base 14 may resemble an island, a mountain, or any land suitable on which the model castle may be assembled.

The model castle 10 may further have flat roofs 25 and conical roofs 26. The conical roofs 26 may provide a cover for the towers 19. A reduced diameter tower portion 34 may be disposed between the towers 19 and the conical roofs 26. A walkway 35 may be defined between the reduced diameter tower portion 34 and the crenellated parapet 12. Each of the towers 19 may have one of the conical roofs 26. The flat roofs 25 may provide a cover for the model castle 10 between opposing walls 20. At least one of the flat roofs 25 may be supported by at least two of the walls 20.

The towers 19 and/or the walls 20 and/or the flat roofs 25 and/or the conical roofs 26 and/or the walkway 35 of the model castle 10 may be made of cardboard, foam, balsa wood or any other material generally known and/or used to construct model castles. The towers 19 and/or the walls 20 of the model castle 10 may further be constructed with paint, stickers, paper and the like to simulate bricks, stones or other construction materials.

Alternatively, the model castle 10 may direct the modeler to assemble the model castle 10 using unfurnished materials.

A window 36 may be placed on the towers 19 and/or the walls 20. The window 36 may be painted onto the towers 19 and/or the walls 20. Alternatively, the window 36 may have an adhesive (not shown) and may be attached to the towers 19 and/or the walls 20 with the adhesive. Further, the window 36 with the adhesive may be removed from the towers 19 and/or the walls 20. A flag 38 may be positioned on a tip 37 of the conical roofs 26.

It should be understood that any number of the towers 19 and/or the walls 20 may be used to build the model castle 10. Further, the towers 19 and/or the walls 20 may be constructed in various shapes and sizes and may have a simple or complex configuration. For example, the towers 19 may be rectangular in shape, cylindrical in shape, or the like. Further, the towers 19 and/or the walls 20 may be manufactured such that the model castle 10 is small enough to fit in a doll house or large enough to be life-size. The model castle 10, for example, may be built simply using four of the walls 20 and the crenellated parapet 12 as a model castle top. Alternatively the model castle 10 may be built with numerous ones of the towers 19 and/or the walls 20 of varying shapes and/or sizes as illustrated in FIG. 1. Further, it should be understood that any model assembly, such as for example, a model house, a model bridge, or the like, may implement the crenellated parapet 12 of the present invention.

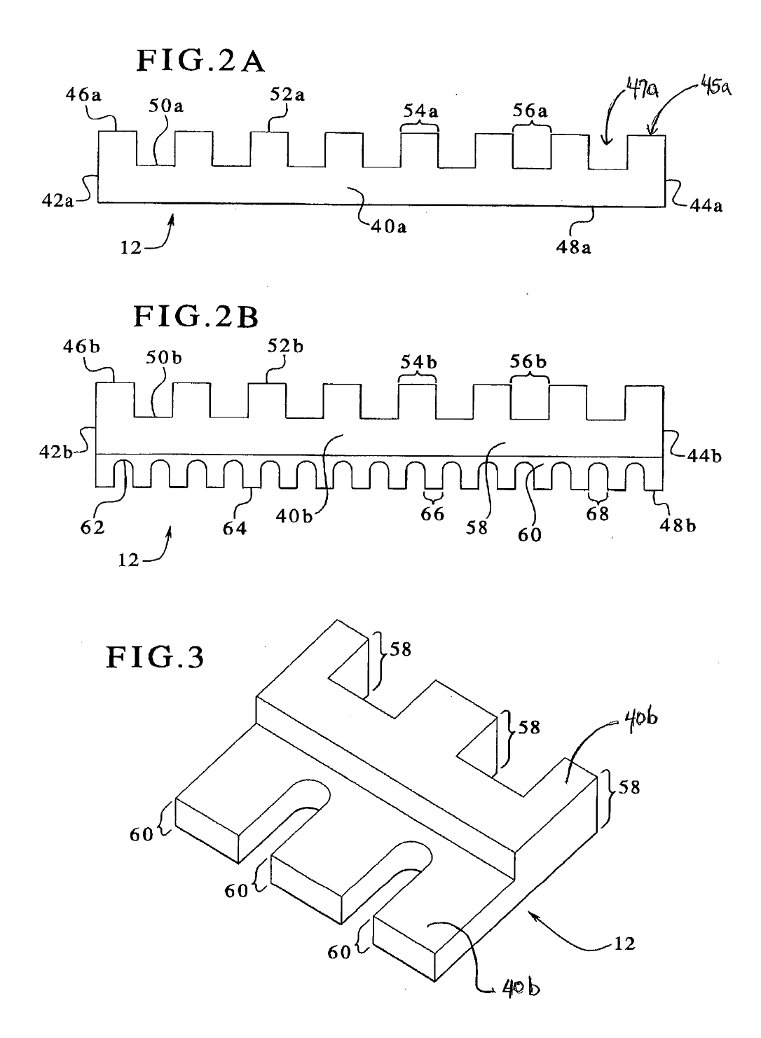

Referring now to FIG. 2A, an embodiment of the crenellated parapet 12 of the present invention is illustrated. The crenellated parapet 12 may have a flat face 40a, two lateral edges 42a and 44a, an upper edge 46a and a lower edge 48a. The upper edge 46a may have alternating low portions 47a and high portions 45a. The lower edge 48a may be flat. The upper edge 46a may further have upper crenels 50a and upper merlons 52a. The upper crenels 50a may alternate with the upper merlons 52a such that each of the upper crenels 50a may be separated with one of the upper merlons 52a. It should be understood that a distance 54a between the upper crenels 50a and a distance 56a between the upper merlons 52a may be the same in length or may differ in length. The distance 54a between the upper crenels 50a and the distance 56a between the upper merlons 52a may be the same. Accordingly, the upper merlons 52a and the upper crenels 50a may have equal lengths. Alternatively, the distance 54a between the upper crenels 50a and the distance 56a between the upper merlons 52a may differ. Accordingly, the upper merlons 52a and the upper crenels 50a may have different lengths. For example, the upper crenels 50a may have twice the length of the upper merlons 52a.

Further, the crenellated parapet 12 may have an upper edge 46a that is flat and a lower edge 48a that is crenellated. Additionally, the upper crenels 50a and the upper merlons 52a of the crenellated parapet 12 may be square, circular, triangular, or of any other shape. Still further, the upper crenels 50a and the upper merlons 52a of the crenellated parapet 12 may have an irregular shape to imitate the model castle 10 in partial ruin.

Referring now to FIG. 2B, another embodiment of the crenellated parapet 12 is illustrated. The crenellated parapet 12 may have a flat face 40b, two lateral edges 42b and 44b, an upper edge 46b and a lower edge 48b. The flat face 40b may have a first thickness 58 and a second thickness 60. The upper edge 46b may have upper crenels 50b and upper merlons 52b. The upper crenels 50b may be spaced a distance 54b between the upper crenels 50b, and the upper merlons 52b may be spaced a distance 56b between the upper merlons 52b. It should be understood that the distance 54b between the upper crenels 50b and the distance 56b between the upper merlons 52b may be the same or may differ. The lower edge 48b may further have lower crenels 62, also referred to as “machicolations”, and lower merlons 64. The lower crenels 62 may be spaced a distance 66 between the lower crenels 62, and the lower merlons 64 may be spaced a distance 68 between the lower merlons 64. It should be understood that the distance 66 or the distance 68 between the lower crenels 62 and the lower merlons 64 may be the same or may differ in length.

Referring to FIG. 3, in an embodiment of the present invention, the crenellated parapet 12 is illustrated in perspective view. The crenellated parapet 12 may have a flat face 40b having the first thickness 58 and the second thickness 60. The first thickness 58 and the second thickness 60 may be integrally formed. Alternatively, the first thickness 58 and the second thickness 60 may be formed by attaching two materials together to form the crenellated parapet 12.

Referring now to FIGS. 2A, 2B and 3, the crenellated parapet 12 may be manufactured in precut lengths or may be manufactured as a roll. The precut lengths may correspond to predetermined lengths used to build the model castle 10, or alternatively, may be provided in uniform or predetermined lengths for ease of packaging. Still further, the crenellated parapet 12 may be cut at any location on the crenellated parapet 12. Further, the crenellated parapet 12 may be attached to the model castle 10 by applying adhesive to the back side (not shown) of the crenellated parapet 12 or may be attached to the model castle 10 mechanically with, for example, pins. Alternatively, the crenellated parapet 12 may have an adhesive layer on the back side. Further, the crenellated parapet 12 may be constructed from foam, plastic, or other flexible material.

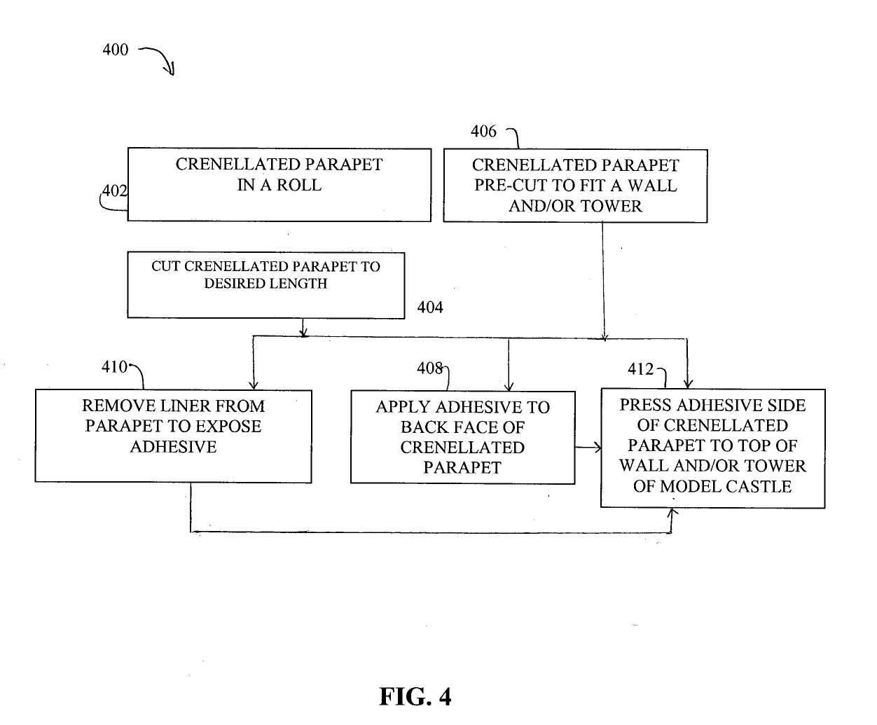

A flowchart 400 illustrating a method for applying the crenellated parapet 12 to the model castle 10 of the present invention is generally illustrated in FIG. 4. The crenellated parapet 12 may be provided in a roll as shown at step 402. The crenellated parapet 12 may be cut to a desired length as shown at step 404. Alternatively, the crenellated parapet 12 may be purchased in pre-cut form to fit, for example, the towers 19 and/or the walls 20 of the model castle 10 as shown at step 406. An adhesive may be applied to the crenellated parapet 12 as shown as step 408. Alternatively, the crenellated parapet 12 may be manufactured with an adhesive and a protective liner, or, may be manufactured without the protective liner. The liner may be removed as shown at step 410. Finally, the adhesive side of the crenellated parapet 12 may be applied to the towers 19 and/or the walls 20 of the model castle 10.

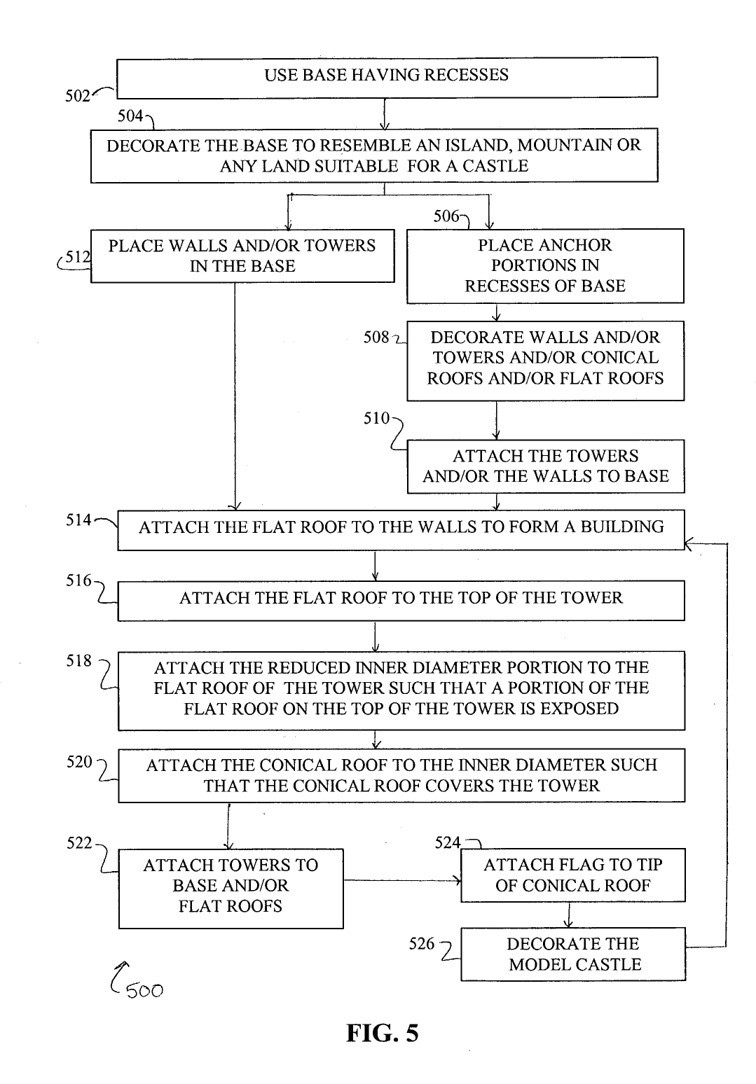

A flowchart 500 illustrating a method for assembling the model castle 10 of the present invention is generally illustrated in FIG. 5. The base 14 having the recesses 16 may be used as shown at step 502. The base 14 may be decorated to resemble an island, mountain, or any other land or medium suitable for a castle as shown at step 504. The anchor portions 18 may be placed in the base 14 as shown at step 506. The walls 20 and/or the towers 19 and/or the flat roofs 25 and/or the conical roofs 26 may be decorated to resemble building parts made of brick, stone, glass or the like, as shown at step 508. The towers 19 and/or the walls 20 may be attached to the base 14 with the anchor portions 18, as shown at step 510. Alternatively, the towers 19 and/or the walls 20 may be placed into the recesses 16 of the base 14 as shown at step 512. Still further, the walls 20 and/or the towers 19 may be free-standing without use of the base 14. If necessary, a floor (not shown) may support the walls 20 and/or the towers 19.

The flat roofs 25 may be attached to the walls 20 to form a building as shown at step 514. The flat roofs 25 may be attached to the top of the towers 19 as shown at step 516. The flat roofs 25 may be attached to the walls 20 and/or the towers 19 with adhesive, pins, or the like. Alternatively, the flat roofs 25 may be attached to the walls 20 by placing the flat roofs 25 on top of the walls 20 without the need for pins and/or adhesive or the like. The reduced diameter tower portions 34 may be attached to the flat roofs 25 of the towers 19 such that a portion of the flat roofs 25 on the towers 19 is exposed as shown at step 518. The conical roofs 26 may be attached to the reduced diameter tower portions 34 such that the conical roofs 26 cover the towers 19 as shown at step 520. The towers 19 may be attached to the base 14 and/or the flat roofs 25 as shown at step 522. A flag 38 may be attached to the tip 37 of each of the conical roofs 26 as shown at step 524. Other decorations may be added to the model castle 10 as shown at step 526. Steps 514-526 may be repeated to build additional floors and/or wings for the model castle 10.

From the foregoing, it can be seen that the model castle 10 may be assembled using the crenellated parapet 12 by children or people with limited dexterity. Further, the model castle 10 may be simple or more complex in configuration depending on the sizes and number of the walls 20 and/or the towers 19 and/or the flat roofs 25 and/or the conical roofs 26 and/or other pieces for building the model castle 10. Still further, the same pieces and methods can be used to build boats, cars, and the like.

It should be understood that various changes and modifications to the presently preferred embodiments described herein will be apparent to those skilled in the art. Such changes and modifications may be made without departing from the spirit and scope of the present invention and without diminishing its attendant advantages. It is therefore intended that such changes and modifications be covered by the appended claims.

I claim:

1. A model castle top for a model castle, the top comprising:
a parapet having a front face, a back face, a top edge and a bottom edge;
a plurality of protrusions attached to the top edge of the parapet wherein the plurality of protrusions are spaced equally apart; and
a plurality of indentations in the top edge of the parapet wherein each of the indentations is between the plurality of protrusions.

2. The model castle top of claim 1 further comprising:
an adhesive layer on the back face of the parapet.

3. The model castle top of claim 1 further comprising:
a second plurality of protrusions attached to the bottom edge of the parapet.

4. The model castle top of claim 1 wherein the parapet is flexible.

5. The model castle top of claim 1 wherein the parapet is made from foam.

6. The model castle top of claim 1 wherein the parapet is made from plastic.

7. The model castle top of claim 1 further comprising:
a second parapet having a front face, a back face, a top edge and a bottom edge wherein the second parapet is attached to the back face of the parapet.

8. A model castle assembly comprising:
a plurality of parapets each having a front face, a back face, a top edge and a bottom edge wherein one of the plurality of parapets has a plurality of protrusions attached to the top edge and further wherein the plurality of protrusions are spaced equally apart; and
a plurality of walls wherein one of the plurality of parapets are attached to at least one of the plurality of walls.

9. The castle model assembly of claim 8 further comprising:
a plurality of towers associated with the plurality of walls.

10. The castle model assembly of claim 8 further comprising:
a base having a recess for supporting the plurality of walls.

11. The castle model assembly of claim 8 further comprising:
a base having a recess for supporting the plurality of walls.

12. The castle model assembly of claim 8 wherein the plurality of parapets are flexible.

13. The castle model assembly of claim 8 further comprising:
a roof attached to the plurality of walls.

14. The castle model assembly of claim 8 further comprising:
a window in one of the plurality of walls.

15. A method for applying a top to a model castle, the method comprising the steps of:
providing a parapet having a front face, a back face, a top edge and a bottom edge wherein the parapet has a plurality of protrusions attached to the top edge of the parapet and further wherein the plurality of protrusions are spaced equally apart;
aligning the parapet to the model castle; and
attaching the parapet to the model castle.

16. The method of claim 15 further comprising the step of:
providing an adhesive on the back side of the parapet.

17. The method of claim 15 further comprising the step of:
sizing the parapet to a desired length.

18. The method of claim 15 further comprising the step of:
attaching two lateral ends of the parapet for positioning on a tower.

19. A method for assembling a model castle, the method comprising the steps of:
providing a plurality of walls;
providing a plurality of towers associated with the plurality of walls;
providing a parapet having a front face, a back face, a top edge and a bottom edge wherein the parapet has a plurality of protrusions attached to the top edge of the parapet wherein the plurality of protrusions are spaced equally apart; and
attaching the parapet to one of the plurality of walls.

20. The method of claim 19 further comprising the step of:
applying adhesive on the back side of the parapet.

21. The method of claim 19 further comprising the step of:
attaching paper simulating construction materials for covering the plurality of walls and the plurality of towers.

22. The method of claim 19 further comprising the step of:
using a base to support the plurality of walls and the plurality of towers.

23. The method of claim 19 further comprising the step of:
attaching a window on one of the plurality of walls.
